(19) United States
(12) Patent Application Publication
(10) Pub. No.: US 2026/0298306 A1
(43) Pub. Date: Oct. 1, 2026

(54) SHOCK-ABSORBER CYLINDER HAVING AN ADJUSTABLE LENGTH AND/OR SHOCK-ABSORBING EFFECT

(71) Applicant: Airbus Operations (S.A.S.), Toulouse (FR)

(72) Inventors: Xavier Kern, Toulouse (FR); Guillaume Degodet, Toulouse (FR)

(21) Appl. No.: 19/572,121

(22) Filed: Mar. 19, 2026

(30) Foreign Application Priority Data
Mar. 26, 2025 (FR) 2503134

(51) Int. Cl. F16F 9/30; F16F 9/32; F16F 9/43; F16F 9/516

(52) U.S. Cl. CPC F16F 9/303; F16F 9/3214; F16F 9/3235; F16F 9/3271; F16F 9/435; F16F 9/516; F16F 2224/025; F16F 2226/04; F16F 2228/066; F16F 2230/36; F16F 2232/08; F16F 2234/02

(57) ABSTRACT

A shock-absorber cylinder includes at least one hollow body, at least one piston which slides in the hollow body and divides it into first and second chambers which are filled with at least one solid and resiliently deformable filling material, at least one rod connected to the piston, first and second anchoring points which are secured respectively to the hollow body and to the rod. Filling the chambers of the shock-absorber cylinder with a solid and resiliently deformable filling material makes it possible to simplify the setting of the length of the shock-absorber cylinder and/or the adjustment of its shock-absorbing effect.

### TECHNICAL FIELD

The disclosure herein relates to a shock-absorber cylinder for obtaining a shock-absorbing effect between two elements which are connected by the cylinder.

### BACKGROUND

According to one embodiment known from the prior art, a shock-absorber cylinder comprises a cylindrical hollow body which extends between first and second end walls, a piston which slides in the hollow body between the first and second end walls, and a rod which passes through the second end wall and extends between first and second ends, the first end of the rod being connected to the piston. The latter divides the hollow body into first and second chambers which are filled with a fluid, each of the chambers having at least one outlet equipped with an adjustment screw for setting the flow rate passing through the outlet.

During operation, the shock-absorber cylinder connects first and second elements, the first end wall of the hollow body and the second end of the rod being connected respectively to the first and second elements. This shock-absorber cylinder makes it possible to obtain a shock-absorbing effect between these elements. It is possible to set the shock-absorbing effect by setting the flow rates of the outlets of the first and second chambers by using the adjustment screws.

These various adjustments increase the complexity of the shock-absorber cylinder and increase the number of separate elements to be assembled in order to form it.

### SUMMARY

It is an object of the disclosure herein to overcome all or some of the drawbacks of the prior art.

For this purpose, the disclosure herein relates to a shock-absorber cylinder comprising:
at least one hollow body, which has a cylindrical side wall as well as first and second end walls at each end of the side wall,
at least one piston, which slides in the hollow body between the first and second end walls and divides the hollow body into first and second chambers,
at least one rod, which can move along a longitudinal direction, passes through the second end wall and extends between first and second ends, the first end of the rod being connected to the piston,
first and second anchoring points which are secured respectively to the hollow body and to the rod.

According to the disclosure herein, the first and second chambers are filled with at least one solid and resiliently deformable filling material, which is in liquid form during the filling of the chambers.

This filling material makes it possible to simplify the adjustment of the length of the shock-absorber cylinder and/or its shock-absorbing effect.

According to another feature, the side wall of the hollow body comprises at least one through-hole, which establishes communication between one chamber among the first and second chambers and an exterior zone of the hollow body.

According to another feature, the side wall of the hollow body comprises at least one first through-hole which opens into the first chamber and at least one second through-hole which opens into the second chamber.

According to another feature, at least one through-hole has an elongate shape which extends between first and second ends, which are offset along the longitudinal direction.

According to another feature, the elongate through-hole has a width which increases between the first and second ends.

According to another feature, the shock-absorber cylinder comprises at least one adjustment ring which is positioned around the hollow body and can move with respect to the latter so as to close the through-hole to a greater or lesser extent.

According to another feature, the shock-absorber cylinder comprises one adjustment ring for each through-hole.

According to another feature, each adjustment ring has a length greater than or equal to that of the through-hole with which it cooperates, so as to fully close the latter in at least one position of the adjustment ring.

According to another feature, the adjustment ring which cooperates with the through-hole comprises at least one through-orifice with a cross section substantially identical to or larger than that of the through-hole.

According to another feature, the shock-absorber cylinder comprises an interface between the hollow body and the filling material, which promotes sliding of the latter with respect to the hollow body.

According to another feature, the filling material is an elastomer material configured to occupy a liquid state for a given period of time, then a solid state after curing.

According to another feature, the hollow body comprises at least one filling orifice which passes through the side wall or the first or second end wall and is configured to allow passage of the filling material in the liquid state.

According to another feature, the hollow body comprises a plurality of filling orifices which are arranged in order to promote optimal filling of the first and second chambers with the filling material in the liquid state.

According to another feature, the piston comprises at least one disc or annulus, which has a first face oriented towards the first chamber, a second face oriented towards the second chamber, a peripheral edge slightly spaced apart from or in contact with the side wall of the hollow body, and at least one through-orifice which connects the first and second faces and allows communication to be established between the first and second chambers.

According to another feature, the piston comprises a plurality of discs or annuli which are parallel and spaced apart from one another.

The disclosure herein also relates to a method for mounting a shock-absorber cylinder according to one of the features above, comprising a step of filling the first and second chambers with the filling material in the liquid state, a step of adjusting a distance separating the first and second anchoring points, then a step of curing the filling material.

According to another feature, before the filling step, the mounting method comprises an assembly step which consists in connecting the first and second anchoring points of the shock-absorber cylinder to first and second elements, the first and second chambers being empty.

### BRIEF DESCRIPTION OF THE DRAWINGS

Other features and advantages will become apparent from the following description of the disclosure herein, the description being given only by way of example and with reference to the appended figures, in which:

FIG. 1 is a longitudinal section of a shock-absorber cylinder, illustrating one embodiment of the disclosure herein, the cylinder being empty in part (A) and filled with a filling material in part (B);

FIG. 2 is a cross section of a part of a shock-absorber cylinder, illustrating one embodiment of the disclosure herein, in the absence of a compression force in part (A) and in the presence of a compression force in part (B);

FIG. 3 is a cross section of a part of a shock-absorber cylinder which comprises an adjustment ring, illustrating one embodiment of the disclosure herein, the adjustment ring occupying different adjustment positions in parts (A) and (B);

FIG. 4 is a lateral view of a shock-absorber cylinder, illustrating another embodiment of the disclosure herein;

FIG. 5 is a longitudinal section of the shock-absorber cylinder shown in FIG. 4;

FIG. 6 is a perspective view of a rod and of a piston of the shock-absorber cylinder shown in FIG. 4;

FIG. 7 is a perspective view of the piston of the shock-absorber cylinder shown in FIG. 4;

FIG. 8 is a perspective view of the shock-absorber cylinder shown in FIG. 4;

FIG. 9 is a perspective view of a part of a shock-absorber cylinder, illustrating one embodiment of the disclosure herein, one of its adjustment rings occupying different angular positions in parts (A), (B) and (C);

FIG. 10 is a perspective view of a part of a shock-absorber cylinder, illustrating one embodiment of the disclosure herein, one of its adjustment rings occupying different longitudinal positions in parts (A) and (B); and

FIG. 11 is a perspective view of a part of a shock-absorber cylinder, illustrating another embodiment of the disclosure herein, one of its adjustment rings occupying different longitudinal positions in parts (A) and (B).

### DETAILED DESCRIPTION

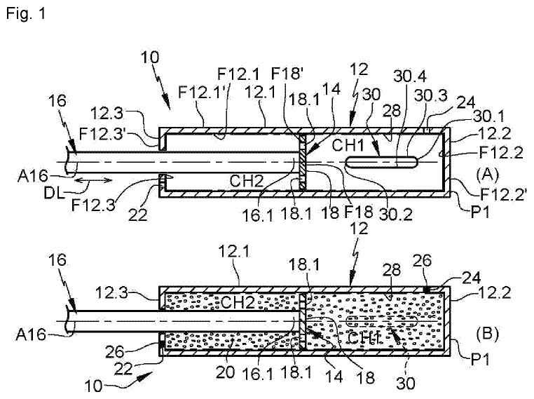

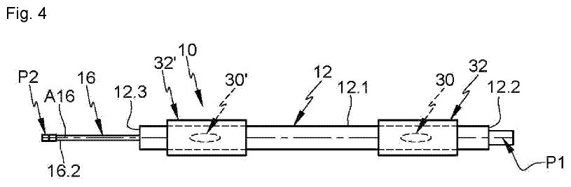

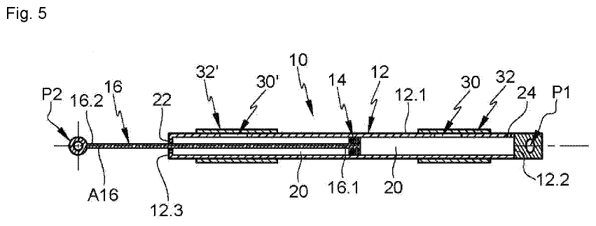

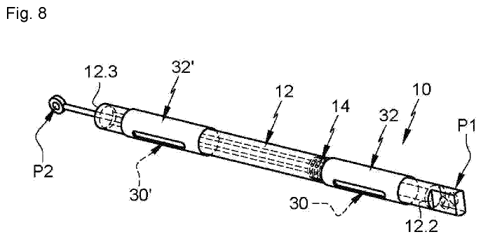

According to one embodiment, which is shown in FIGS. 1, 4, 5 and 8, a shock-absorber cylinder 10 comprises:
a. at least one hollow body 12, which has a cylindrical side wall 12.1 as well as first and second end walls 12.2, 12.3 at each end of the side wall 12.1,
b. at least one piston 14, which slides in the hollow body 12 between the first and second end walls 12.2, 12.3,
c. at least one rod 16 which passes through the second end wall 12.3 and extends between first and second ends 16.1, 16.2, the first end 16.1 of the rod 16 being connected to the piston 14.

The piston 14 divides the hollow body 12 into first and second chambers CH1, CH2.

The side wall 12.1 and the end walls 12.2, 12.3 of the hollow body 12 comprise internal faces F12.1, F12.2, F12.3, which are oriented towards the first or second chamber CH1, CH2, as well as external faces F12.1′, F12.2′, F12.3′ opposite the internal faces F12.1, F12.2, F12.3.

The rod 16 is substantially cylindrical and has an axis A16 which merges with that of the cylindrical side wall 12.1 of the hollow body 12.

During operation, the piston 14 and the rod 16 move in translation along a longitudinal direction DL, which is parallel to the axes of the rod 16 and of the cylindrical side wall 12.1 of the hollow body 12.

The shock-absorber cylinder 10 comprises first and second anchoring points P1 and P2, which are secured respectively to the hollow body 12 and to the rod 16, for securing the shock-absorber cylinder 10 to first and second elements. The shock-absorber cylinder 10 makes it possible to obtain a shock-absorbing effect between these elements.

According to one configuration, the first and second anchoring points P1 and P2 are positioned respectively at the first end wall 12.2 of the hollow body 12 and at the second end 16.2 of the rod 16. By way of example, the first anchoring point P1 comprises an extension through which a hole passes and which is secured to the first end wall 12.2 of the hollow body 12 and the second anchoring point P2 comprises a fastening annulus which is secured to the second end 16.2 of the rod 16.

According to one embodiment, the hollow body 12, the piston 14 and the rod 16 are made of rigid materials. They may be made of metal or of composite material.

The piston 14 comprises at least one disc or annulus 18, which has a first face F18 oriented towards the first chamber CH1, a second face F18′ oriented towards the second chamber CH2 and a peripheral edge, which is slightly spaced apart from or is in contact with the side wall 12.1 of the hollow body 12. According to one configuration, the disc or the annulus 18 has at least one through-orifice 18.1 which connects the first and second faces F18, F18′ and allows communication to be established between the first and second chambers CH1, CH2.

According to a first arrangement, which is shown in FIG. 1, the piston 14 comprises a single disc or annulus 18.

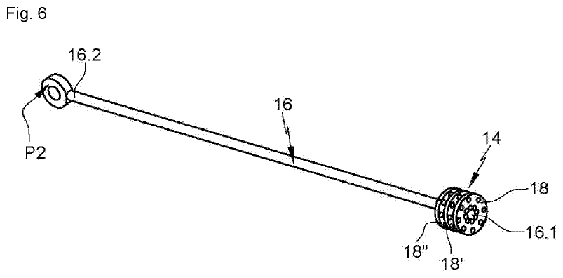

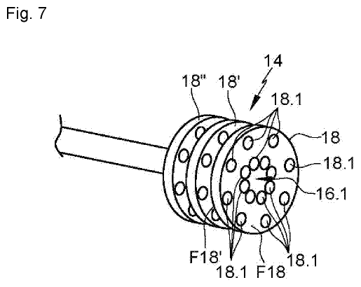

According to a second arrangement, which is shown in FIGS. 6 and 7, the piston 14 comprises a plurality of discs or annuli 18, 18′, 18″, which are substantially parallel and slightly spaced apart from one another, each provided with a plurality of through-orifices 18.1 which allow communication to be established between the first and second chambers CH1, CH2. These various discs or annuli 18, 18′, 18″ are connected rigidly to the rod 16.

According to one particular feature of the disclosure herein, the first and second chambers CH1, CH2 are filled with at least one solid and resiliently deformable filling material 20. According to one embodiment, the filling material 20 is an elastomer material. By way of example, the filling material 20 may be polyurethane or silicone. This list is not exhaustive.

The filling material 20 is configured to occupy a liquid state for a given period of time, then a solid state after curing.

According to one embodiment, the hollow body 12 comprises at least one filling orifice 22 which passes through the side wall 12.1 or the first or second end wall 12.2, 12.3 and is configured to allow passage of the filling material 20 in the liquid state.

According to one configuration, the hollow body 12 comprises a plurality of filling orifices 22, 24 which are arranged in order to promote optimal filling of the first and second chambers CH1, CH2 with the filling material 20. The hollow body 12 thus comprises first and second filling orifices 22, 24, passing through the side wall 12.1 or the first or second end wall 12.2, 12.3, which are as far apart as possible. According to one arrangement, the first filling orifice 22 is located at the second end wall 12.3 and the second filling orifice 24 is located at the side wall 12.1, in proximity to the first end wall 12.2.

According to one embodiment, the shock-absorber cylinder 10 comprises, for each filling orifice 22, 24, a plug 26 which is configured to close the filling orifice 22, 24 after the first and second chambers CH1, CH2 have been filled.

During operation, the first and second anchoring points P1 and P2 are separated by a given distance.

According to one assembly mode, a method for mounting the shock-absorber cylinder 10 comprises:
a. a step of filling the first and second chambers CH1, CH2 with the filling material 20 in the liquid state,
b. a step of adjusting the distance separating the first and second anchoring points P1 and P2, then
c. a step of curing the filling material 20.

According to one operating mode, before the filling step, the mounting method comprises an assembly step which consists in connecting the first and second anchoring points P1 and P2 of the shock-absorber cylinder 10 to the first and second elements, the first and second chambers CH1, CH2 being empty.

Prior to the filling step, the filling orifices 22, 24 are opened in order to inject the filling material 20 into at least one of the first and second chambers CH1, CH2. After the filling step, the plugs 26 are inserted in order to close the filling orifices 22, 24.

During the filling step, the filling material 20 passes through the piston 14 via the through-orifices 18.1 of the discs 18, 18′, 18″ in order to move from one chamber CH1, CH2 to the other.

The filling material 20 forms a solid cylinder which has a diameter substantially equal to the interior diameter of the side wall 12.1 of the hollow body 12 and a length substantially equal to the distance separating the first and second end walls 12.2, 12.3, the piston 14 being embedded in the filling material 20.

According to one configuration, the filling material 20 in the solid state does not adhere to the hollow body 12 and can slide with respect to the hollow body 12. In this sense, the shock-absorber cylinder 10 comprises an interface between the hollow body 12 and the filling material 20 in the solid state, which promotes sliding of the latter with respect to the hollow body 12.

Prior to the filling step, the internal faces F12.1, F12.2, F12.3 of the side wall 12.1 and of the end walls 12.2, 12.3 comprise a mould release coating 28 in order that the filling material 20 in the solid state does not adhere to the hollow body 12.

The mould release coating 28 is a mould release agent such as, for example, a coating of polytetrafluoroethylene or a liquid mould release agent based on polytetrafluoroethylene. This list is not exhaustive.

According to one embodiment, the side wall 12.1 of the hollow body 12 comprises at least one through-hole 30 which connects the internal and external faces F12.1, F12.1′ and establishes communication between the first or second chamber CH1, CH2 and an exterior zone of the hollow body 12.

According to one configuration, the side wall 12.1 of the hollow body 12 comprises at least one first through-hole 30 which opens into the first chamber CH1 and at least one second through-hole 30′ which opens into the second chamber CH2.

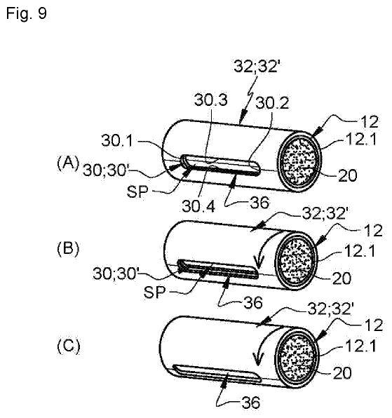

According to one configuration, which is shown for example in FIG. 9, each through-hole 30 has an elongate shape which extends between first and second ends 30.1, 30.2, which are offset along the longitudinal direction DL, and has first and second lateral edges 30.3, 30.4 which are parallel to the longitudinal direction DL and connect the first and second ends 30.1, 30.2. Each through-hole 30 has a length which corresponds to the distance separating the first and second ends 30.1, 30.2 and a width which corresponds to the distance separating the first and second lateral edges 30.3, 30.4.

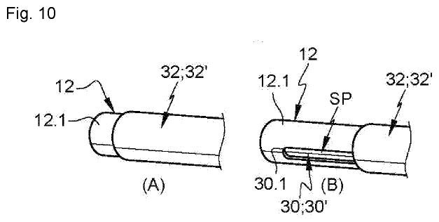

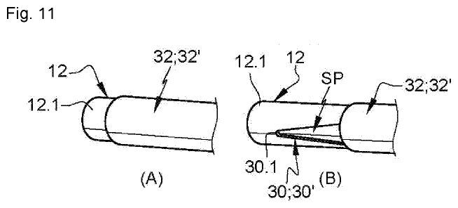

According to one embodiment, which is shown in FIGS. 9 and 10, the width is constant between the first and second ends 30.1, 30.2. According to another embodiment, which is shown in FIG. 11, the width varies between the first and second ends 30.1, 30.2. By way of example, the width increases between the first and second ends 30.1, 30.2. In this case, the through-hole 30 has a triangular shape (as illustrated in FIG. 11) which makes it possible to obtain an exponential shock-absorbing effect.

The disclosure herein is of course not limited to these shapes for the through-holes 30, 30′.

Regardless of the embodiment, each through-hole 30, 30′ comprises a passage zone ZP which corresponds to a volume located between the internal and external faces F12.1, F12.1′ and delimited by the wall of the through-hole 30, 30′.

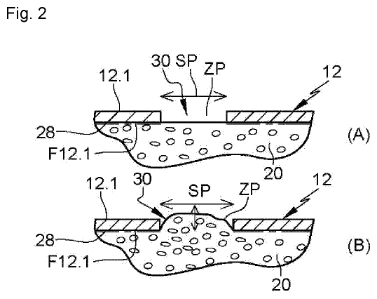

During operation, when the filling material 20 is stretched in the first or second chamber CH1, CH2, the filling material 20 is not present in the passage zone ZP, as illustrated in part (A) of FIG. 2. When the filling material 20 is compressed in the first or second chamber CH1, CH2, the filling material 20 is present in the passage zone ZP, as illustrated in part (B) of FIG. 2, and tends to emerge from the hollow body 12.

Each through-hole 30, 30′ has a passage cross section SP which corresponds to an area delimited by the wall of the through-hole 30, 30′ and located in a plane between the internal and external faces F12.1, F12.1′. The shock-absorber cylinder 10 has a shock-absorbing effect as a function of the passage cross section SP.

According to one embodiment, the shock-absorber cylinder 10 comprises, for at least one through-hole 30, at least one adjustment ring 32 which is positioned around the hollow body 12 and can move with respect to the latter so as to close the through-hole 30 to a greater or lesser extent. This adjustment ring 32 comprises a cylindrical interior face F32 which has a diameter substantially equal to that of the external face F 12.1′ of the side wall 12.1 of the hollow body 12.

According to one configuration, the shock-absorber cylinder 10 comprises one adjustment ring 32 for each through-hole 30, 30′. The shock-absorber cylinder 10 thus comprises a first adjustment ring 32, which is configured to cooperate with the first through-hole 30, and a second adjustment ring 32′, which is configured to cooperate with the second through-hole 30′.

According to one arrangement, each adjustment ring 32, 32′ has a length (dimension taken along the longitudinal direction) greater than or equal to that of the through-hole 30, 30′ with which it cooperates, so as to fully close the through-hole 30, 30′ in at least one position of the adjustment ring 32, 32′.

During the step of filling the first and second chambers CH1, CH2 with the filling material 20, all the through-holes 30, 30′ are fully closed by the adjustment rings 32, 32′.

Prior to the filling step, an interface such as, for example, a mould release coating 34 is interposed between each adjustment ring 32, 32′ and the hollow body 12 in order to allow the adjustment ring 32, 32′ to be displaced with respect to the hollow body 12 after the curing of the filling material 20.

According to one adjustment mode, which is shown in FIG. 9, at least one of the adjustment rings 32, 32′ can pivot about the hollow body.

According to another adjustment mode, which is shown in FIGS. 10 and 11, at least one of the adjustment rings 32, 32′ can move in translation along the longitudinal direction DL with respect to the hollow body 12.

According to another embodiment, at least one of the adjustment rings 32, 32′ can pivot about the hollow body 12 and move in translation along the longitudinal direction DL with respect to the hollow body 12.

According to one configuration, which is shown in FIG. 9, at least one adjustment ring 32, 32′ cooperating with a through-hole 30, 30′ (while covering it with a greater or lesser extent) comprises at least one through-orifice 36 with a cross section substantially identical to or larger than that of the through-hole 30, 30′. According to this configuration, the passage cross section of the through-hole 30, 30′ corresponds to the zone of the through-hole 30, 30′ which is not covered by the adjustment ring 32, 32′ and coincides with the through-orifice 36.

Regardless of the movement of the adjustment ring 32 with respect to the hollow body 12, the shock-absorbing effect of the shock-absorber cylinder 10 varies as a function of the passage cross section SP of the through-hole 30, 30′ that is not covered by the adjustment ring 32, 32′, which itself varies as a function of the (longitudinal or angular) position of the adjustment ring 32, 32′ with respect to the hollow body 12.

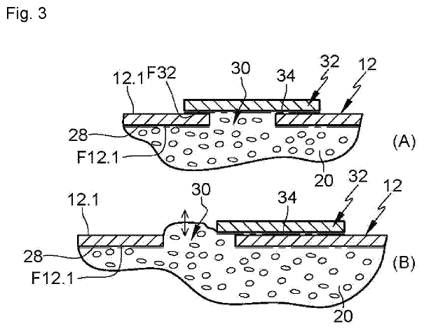

During operation, when the adjustment ring 32, 32′ covers the entire through-hole 30, 30′, as illustrated in part (A) of FIG. 3, the shock-absorber cylinder 10 has a maximum compressive or tensile resistance. When the adjustment ring 32, 32′ covers the through-hole 30, 30′ partially, as illustrated in part (B) of FIG. 3, the shock-absorber cylinder 10 has a compressive resistance which is less than the maximum compressive resistance. When the adjustment ring 32, 32′ uncovers the entire through-hole 30, 30′, the shock-absorber cylinder 10 has a minimum compressive or tensile resistance.

When the piston 14 moves in translation towards the first end wall 12.2, the filling material 20 present in the first chamber CH1 is compressed whereas the filling material present in the second chamber CH2 is stretched. It is possible to increase the compressive resistance of the shock-absorber cylinder 10 by reducing the passage cross section of the first through-hole 30 (which opens into the first chamber CH1) by using the first adjustment ring 32.

When the piston 14 moves in translation towards the second end wall 12.3, the filling material 20 present in the first chamber CH1 is stretched whereas the filling material present in the second chamber CH2 is compressed. It is possible to increase the tensile resistance of the shock-absorber cylinder 10 by reducing the passage cross section of the second through-hole 30′ (which opens into the second chamber CH2) by using the second adjustment ring 32′.

According to the disclosure herein, the tensile and compressive resistances can be set independently of one another.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A shock-absorber cylinder comprising:
at least one hollow body, which has a cylindrical side wall as well as first and second end walls at each end of the side wall;
at least one piston, which can slide in the hollow body between the first and second end walls and divides the hollow body into first and second chambers;
at least one rod, which can move along a longitudinal direction, passes through the second end wall and extends between first and second ends, the first end of the rod being connected to the piston;
first and second anchoring points which are secured respectively to the hollow body and to the rod;
wherein the first and second chambers are filled with at least one solid and resiliently deformable filling material, which is in liquid form during filling of the chambers.

2. The shock-absorber cylinder according to claim 1, wherein the side wall of the hollow body comprises at least one through-hole, which establishes communication between one chamber among the first and second chambers and an exterior zone of the hollow body.

3. The shock-absorber cylinder according to claim 2, wherein the side wall of the hollow body comprises at least one first through-hole which opens into the first chamber and at least one second through-hole which opens into the second chamber.

4. The shock-absorber cylinder according to claim 2, wherein at least one through-hole has an elongate shape which extends between first and second ends, which are offset along the longitudinal direction.

5. The shock-absorber cylinder according to claim 4, wherein the elongate through-hole has a width which increases between the first and second ends.

6. The shock-absorber cylinder according to claim 1, wherein the shock-absorber cylinder comprises at least one adjustment ring which is positioned around the hollow body and can move to close the through-hole to a greater or lesser extent.

7. The shock-absorber cylinder according to claim 6, wherein the shock-absorber cylinder comprises one adjustment ring for each through-hole.

8. The shock-absorber cylinder according to claim 6, wherein each adjustment ring has a length greater than or equal to a length of the through-hole with which it cooperates, so as to fully close the through-hole in at least one position of the adjustment ring.

9. The shock-absorber cylinder according to claim 6, wherein the adjustment ring which cooperates with the through-hole comprises at least one through-orifice with a cross section substantially identical to or larger than a cross section of the through-hole.

10. The shock-absorber cylinder according to claim 1, wherein the shock-absorber cylinder comprises an interface between the hollow body and the filling material, which promotes sliding of the filling material with respect to the hollow body.

11. The shock-absorber cylinder according to claim 1, wherein the filling material is an elastomer material configured to occupy a liquid state for a given period of time, then a solid state after curing.

12. The shock-absorber cylinder according to claim 11, wherein the hollow body comprises at least one filling orifice which passes through the side wall or the first or second end wall and is configured to allow passage of the filling material in the liquid state.

13. The shock-absorber cylinder according to claim 12, wherein the hollow body comprises a plurality of filling orifices which are arranged to promote optimal filling of the first and second chambers with the filling material in the liquid state.

14. The shock-absorber cylinder according to claim 11, wherein the piston comprises at least one disc or annulus, which has a first face oriented towards the first chamber, a second face oriented towards the second chamber, a peripheral edge slightly spaced apart from or in contact with the side wall of the hollow body, and at least one through-orifice which connects the first and second faces and allows communication to be established between the first and second chambers.

15. The shock-absorber cylinder according to claim 14, wherein the piston comprises a plurality of discs or annuli which are parallel and spaced apart from one another.

16. A method for mounting the shock-absorber cylinder according to claim 11, comprising a step of filling the first and second chambers with the filling material in the liquid state, a step of adjusting a distance separating the first and second anchoring points, then a step of curing the filling material.

17. The mounting method according to claim 16, wherein, before the filling step, the mounting method comprises an assembly step comprising connecting the first and second anchoring points of the shock-absorber cylinder to first and second elements, the first and second chambers being empty.
